(19) United States
(12) Patent Application Publication
(10) Pub. No.: US 2003/0191692 A1
(43) Pub. Date: Oct. 9, 2003

(54) Method for a restaurant to do business including the step of providing hand sanitizer to customers

(76) Inventor: Philip S. Vogel, Galena, KS (US)

Correspondence Address: MARTIN & ASSOCIATES, LLC, P O BOX 548, CARTHAGE, MO, 64836-0548, US

(21) Appl. No.: 10/116,845

(22) Filed: Apr. 5, 2002

(51) Int. Cl. G06F 17/60

(52) U.S. Cl. 705/15

(57) ABSTRACT

A method for a restaurant to do business includes the step of providing hand sanitizer in one or more dispensers in one or more public non-bathroom areas of a restaurant. The preferred hand sanitizer is alcohol-based gel. Dispensers are most preferably placed near where food is served to remind customers to sanitize their hands before handling food. In addition, one or more dispensers could be placed near an entrance to the restaurant, or in any other public non-bathroom area of the restaurant.

### BACKGROUND OF THE INVENTION

1. Technical Field

This invention generally relates to the food service industry, and more particularly relates methods for restaurants to do business.

2. Background Art

Restaurants provide a way for customers to eat without taking the time to prepare the food and without the need for the customer to clean up the mess. A vast array of different types of restaurants are known, including fast food chains, locally-owned diners and delis, and more expensive restaurants, including both national chains and local speciality restaurants. Among the more common types of restaurants are fast food restaurants and restaurants that serve food buffet-style, where each customer self-serves food from a food bar onto a plate according to the customer's preferences.

Fast food is popular because it takes little time to prepare and it is relatively inexpensive. This makes fast food a popular choice for families with small children that might become impatient waiting for food to arrive at a traditional restaurant. One issue that arises is that children often have dirty hands, and parents don't always think to have the children wash their hands before eating. The bathrooms in most fast-food restaurants are typically located towards the back of the restaurant. For a parent to assure that their hands and the hands of their children are clean before eating, the parent must take the children to the public restrooms in the restaurant and have them wash with soap and water. This requires thought and effort that many parents do not consistently make. In addition, having each person in the family wash their hands in the bathrooms is problematic with single parents that have small children of the opposite sex, because the child may be old enough that it makes the parent uncomfortable to take the child into the wrong bathroom, yet may be young enough that sending the child into the right bathroom alone causes concern for the safety of the child. Because washing hands in the restaurant's bathrooms is time-consuming and inconvenient, many people don't go to the trouble, and many don't even think to do it. The result is that people often eat restaurant food with unsanitary hands.

Buffets are becoming more and more popular in the United States. In a buffet, food is placed in serving areas of the restaurant that allow the customers to self-serve the food from containers in a food bar. Each customer typically picks up a spoon or other serving utensil, and serves himself or herself according to his or her preferences and tastes. This allows the customer to try many different dishes, rather than being limited to a single dish or predefined combinations when ordering from a menu. In addition, buffets typically allow customers to eat all they want, making this an attractive option for those who enjoy eating a lot.

One problem with buffets is that unclean hands can easily spread germs from one customer to the next, since all customers handle the same serving utensils to dish up their food. Restaurant personnel typically do not monitor the cleanliness of the hands of its customers, because doing so might offend a customer whose hands are not clean. Furthermore, visible dirt and filth are actually less of a concern than germs, which cannot be seen by a visual inspection. For example, a person with a cold could sneeze in their hand just before entering the restaurant. When dishing up food from the buffet, the germs on the person's hand are easily transmitted to the serving utensil. When the next person uses that serving utensil, the germs are now on his or her hands. Often buffets include “finger foods” such as chicken wings, french fries, etc. Eating finger foods with hands that were infected by germs from another person handling a common serving utensil can result in the person contracting an illness or disease. This transmission could be easily prevented if there were some simple and convenient way for restaurant customers to sanitize their hands without having to go to the bathroom and wash with soap and water. Without a way for restaurant customers to conveniently sanitize their hands prior to eating or handling food, the problems associated with unsanitary hands in restaurants will continue.

### DISCLOSURE OF INVENTION

According to the preferred embodiments, a method for a restaurant to do business includes the step of providing hand sanitizer in one or more dispensers in one or more public non-bathroom areas of a restaurant. The preferred hand sanitizer is alcohol-based gel. Dispensers are most preferably placed near where food is served to remind customers to sanitize their hands before handling food. In addition, one or more dispensers could be placed near an entrance to the restaurant, or in any other public non-bathroom area of the restaurant.

The foregoing and other features and advantages of the invention will be apparent from the following more particular description of preferred embodiments of the invention, as illustrated in the accompanying drawings.

### BRIEF DESCRIPTION OF DRAWINGS

The preferred embodiments of the present invention will hereinafter be described in conjunction with the appended drawings, where like designations denote like elements, and:

FIG. 1 is a flow diagram of a prior art method for a restaurant to do business including the step of providing soap in bathrooms so customers can wash their hands;

FIG. 2 is a floor plan of a sample fast food restaurant;

FIG. 3 is a flow diagram of a prior art method for a healthcare provider to do business including the step of providing hand sanitizer in non-public areas of a healthcare facility for use by the healthcare staff;

FIG. 4 is a flow diagram of a method for a restaurant to do business in accordance with the preferred embodiments;

FIG. 5 is a sample sign that reminds customers of a buffet restaurant to sanitize their hands before handling food;

FIG. 6 is a floor plan of a sample fast food restaurant that does business according to the method of FIG. 4;

FIG. 7 is a floor plan of a sample buffet restaurant that does business according to the method of FIG. 4;

FIG. 8 is a front view of a suitable dispenser that could be used to dispense the hand sanitizer in accordance with the preferred embodiments;

FIG. 9 is a front view of one suitable hand sanitizing station in accordance with the preferred embodiments that includes three dispensers for dispensing hand sanitizer; and

FIG. 10 is a perspective view of a free-standing multiple dispenser station for dispensing hand sanitizer in accordance with the preferred embodiments.

### BEST MODE FOR CARRYING OUT THE INVENTION

The methods of the preferred embodiments improve the health of our society by providing an easy way for restaurant customers to sanitize their hands before handling food. In addition, the methods of the preferred embodiments provide a significant competitive advantage to a restaurant owner that can advertise more sanitary conditions due to providing hand sanitizer to customers in public non-bathroom areas of the restaurant.

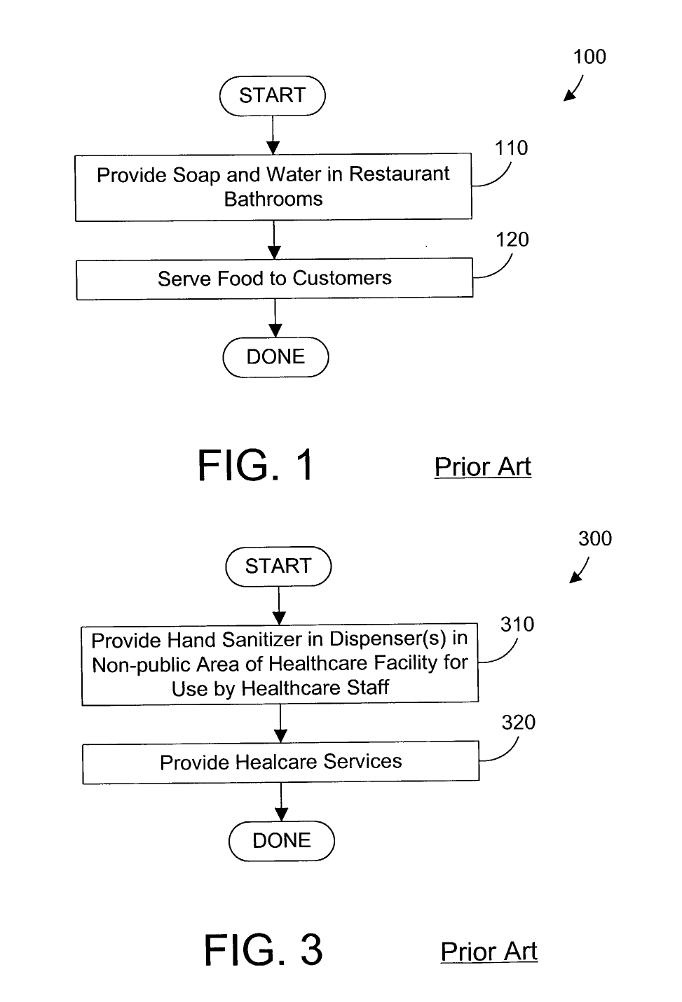

Referring to FIG. 1, a prior art method 100 for a restaurant to do business is shown. The restaurant provides soap and water in public bathrooms of the restaurant (step 110). The restaurant serves food to its customers (step 120). By making soap and water available in bathrooms, restaurants provide a way for customers to wash their hands. However, this is often inconvenient, as described in the Background section above. In addition, the bathroom facilities may make the hand washing process less than completely effective. For example, if the bathrooms have cloth towels, these towels can easily transmit germs to other people. Even if the bathrooms have paper towels or air hand dryers, people often touch these as they use them, which could potentially spread germs to others that later use them. In addition, many customers think to wash their hands in the bathroom after using the toilet or urinal, but do not think of washing their hands before handling their food. We thus see that providing soap and water in bathrooms of a restaurant has many drawbacks.

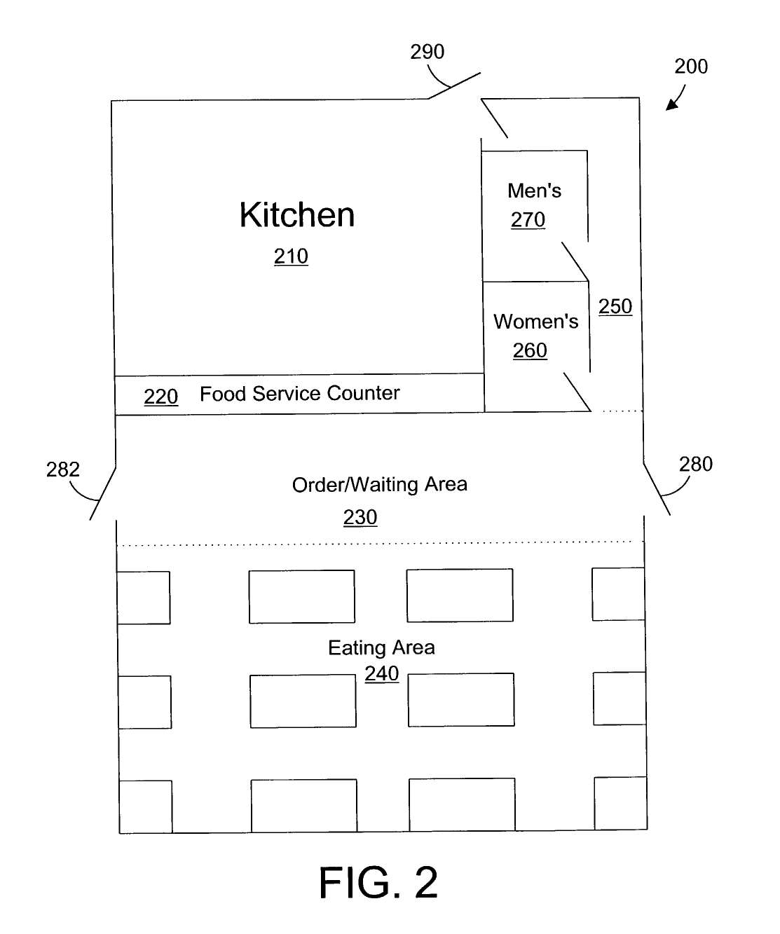

FIG. 2 shows one sample fast food restaurant 200 to illustrate the limitations of prior art method 100 shown in FIG. 1. Restaurant 200 includes a kitchen area 210, a food service counter 220, an order/waiting area 230, an eating area 240, a hallway 250, a women's bathroom 260, and a men's bathroom 270. Customers can enter and exit the restaurant via either of two doors 280 and 282. Employees typically enter and exit via a different door 290 that is not open to the public.

The public areas of restaurant 200 include the food service counter 220, where customers receive their food; order/waiting area 230; eating area 240; hallway 250; women's bathroom 260; and men's bathroom 270. The kitchen 210 is typically not open to the public. Let's assume that restaurant 200 is a fast-food hamburger restaurant. A customer enters at either door 280 or door 282, approaches the food service counter 220, and waits until an employee is ready to take his or her order. We assume for this example that the cash registers are located on the food service counter, as is commonly known in the art. The customer places his or her order, pays, then waits for the food to be presented on the food service counter, typically on a tray. The customer then takes the tray to the eating area 240 to eat the food. Eating area 240 typically contains booths and/or tables that allow customers to sit down while eating.

Note that restrooms 260 and 270 are located towards the back of the restaurant, down a hallway 250. This is very typical of fast food restaurants in the United States. A customer entering restaurant 200 first sees the order/waiting area 230, and often does not think about washing hands in the bathroom before eating. In fact, many customers view the soap and water in a restroom to be there for the purpose of sanitizing one's hands after using the toilet or urinal, and often don't think of using the soap and water in a restaurant bathroom for washing hands before eating. As a result, most customers of fast food restaurants eat their food with hands that have not been sanitized.

Waterless hand sanitizers have been developed in recent years that provide a way for a person to sanitize his or her hands without washing with soap and water. The most commonly-known are alcohol-based gels, such as Purell® manufactured by GOJO Industries, Inc. These alcohol-based gels have gained some acceptance in the healthcare industry as a quick and convenient way to sanitize hands. Referring to FIG. 3, a prior art method 300 for providing healthcare services provides hand sanitizer in non-public areas of a healthcare facility for the healthcare staff to use (step 310). The healthcare staff provides healthcare services (step 320). The result of providing the hand sanitizer to the healthcare staff is that the likelihood of spreading infections is greatly reduced, and the easy and convenience of sanitizing hands is greatly increased compared to washing with soap and water.

While providing hand sanitizer to healthcare workers is known, as shown by method 300 of FIG. 3, providing hand sanitizer in a restaurant environment is unknown. Furthermore, even if the use of hand sanitizer as taught in the healthcare field could be applied to the restaurant business, the result would be the placement of hand sanitizer dispensers in non-public areas (such as the kitchen) so that workers could keep their hand sanitized while preparing food. Nowhere does the prior art teach, suggest, or render obvious the providing of hand sanitizer to customers in a restaurant. This is the subject matter of the preferred embodiments.

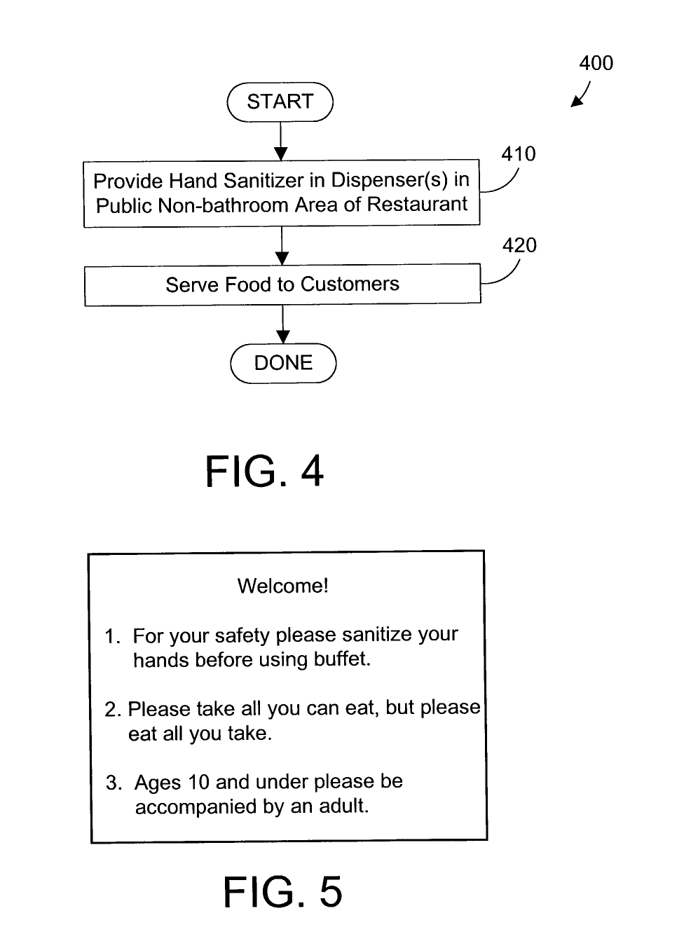

Referring now to FIG. 4, a method 400 for a restaurant to do business in accordance with the preferred embodiments includes the steps of: providing hand sanitizer in dispensers in public non-bathroom areas of a restaurant (step 410); and serving food to customers (step 420). The hand sanitizer is preferably waterless hand sanitizer, is more preferably alcohol-based gel, and is most preferably an ethanol-based gel, such as Purell® manufactured by GOJO Industries, Inc., One GOJO Plaza, Suite 500, Akron, Ohio, 44311. Other types of alcohol are also effective in such hand sanitizer gels, including isoproponal and proponal. The preferred embodiments expressly extend to the use of any suitable hand sanitizer that may be applied to hands -to kill germs, that does not require water or soap, and is self-drying on the hands.

Another step that may optionally be added to method 400 within the scope of the preferred embodiments is for the restaurant to encourage customers to use the hand sanitizer before handling food. This may be done in any suitable way, including signs at the food service counter or at the food bars, or by servers or other workers making customers aware of the hand sanitizer stations. One suitable sign for a buffet restaurant is shown in FIG. 5. Note that the reminder to sanitize hands may be given on a sign that includes other information or instructions, as shown in FIG. 5.

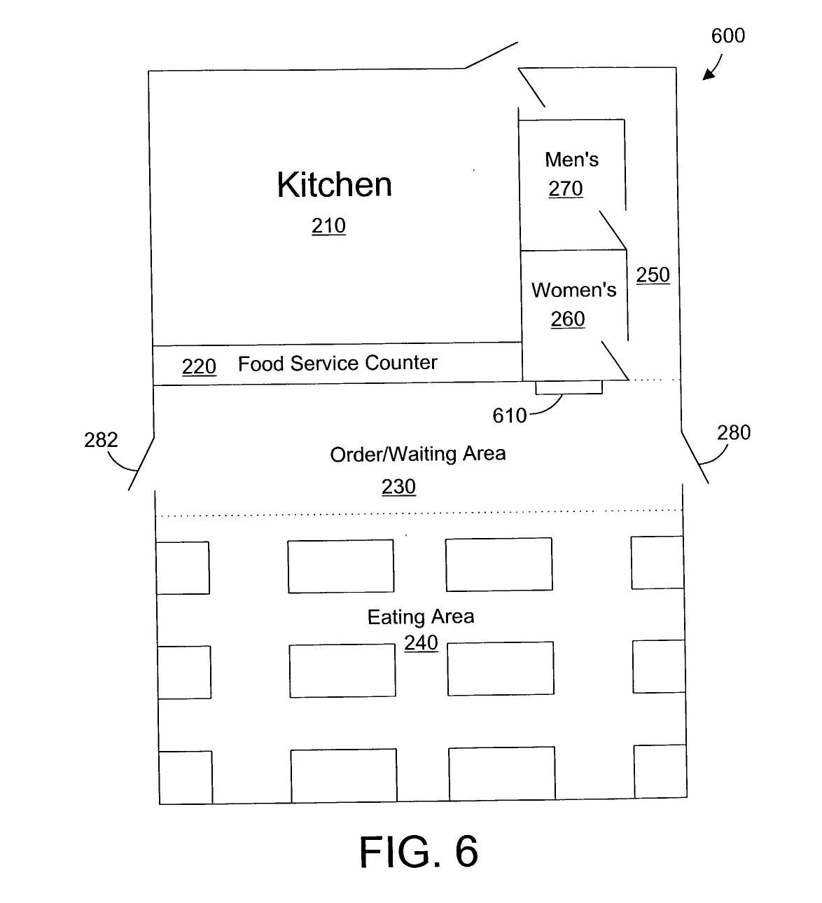

Referring now to FIG. 6, a sample fast food restaurant 600 is similar to the sample fast food restaurant 200 shown in FIG. 2, but additionally includes a hand sanitizer station 610. A hand sanitizer station 610 may be located in any suitable public non-bathroom area in the restaurant. For example, the hand sanitizer station 610 could be placed near each public access door so that customer's see the hand sanitizer station 610 when they enter the restaurant and are reminded to sanitize their hands. Hand sanitizer station 610 could also be placed in the order/waiting area 230, so that customers can sanitize their hands while waiting to order or receive their food. Two hand sanitizer stations 610 could also be placed on each end of the food service counter 220. Hand sanitizer station 610 could also be placed within the eating area 240. Each hand sanitizer station 610 could include a single dispenser, or multiple dispensers in any suitable arrangement. The preferred embodiments expressly extend to the placement of any number of hand sanitizer dispensers in any number of public non-bathroom locations in a restaurant.

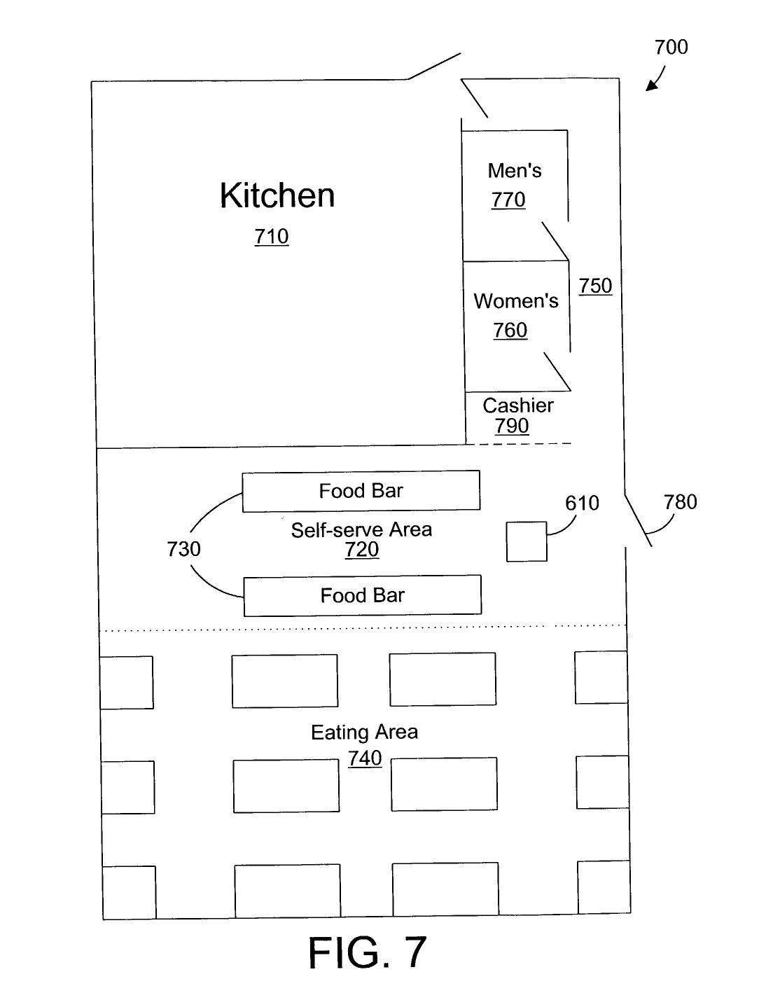

Referring to FIG. 7, a sample buffet restaurant 700 is shown that includes a hand sanitizer station 610 within a public non-bathroom area of the restaurant. Buffet restaurant 700 includes a kitchen area 710, a self-serve area 720, an eating area 740, a hallway 750, a women's bathroom 760, and a men's bathroom 770. Self-serve area 720 typically includes one or more food bars 730. As described above for the sample fast food restaurant 600 in FIG. 6, any number of hand sanitizer dispensers can be located in any public non-bathroom area of a restaurant within the scope of the preferred embodiments. The specific example in FIG. 7 shows a hand sanitizer station 610 in the self-serve area, in proximity to the food bars 730 and in proximity to the main entrance door 780. In this location, the hand sanitizer station 610 serves as a visual reminder for customers to sanitize their hands before handling food at the food bars 730.

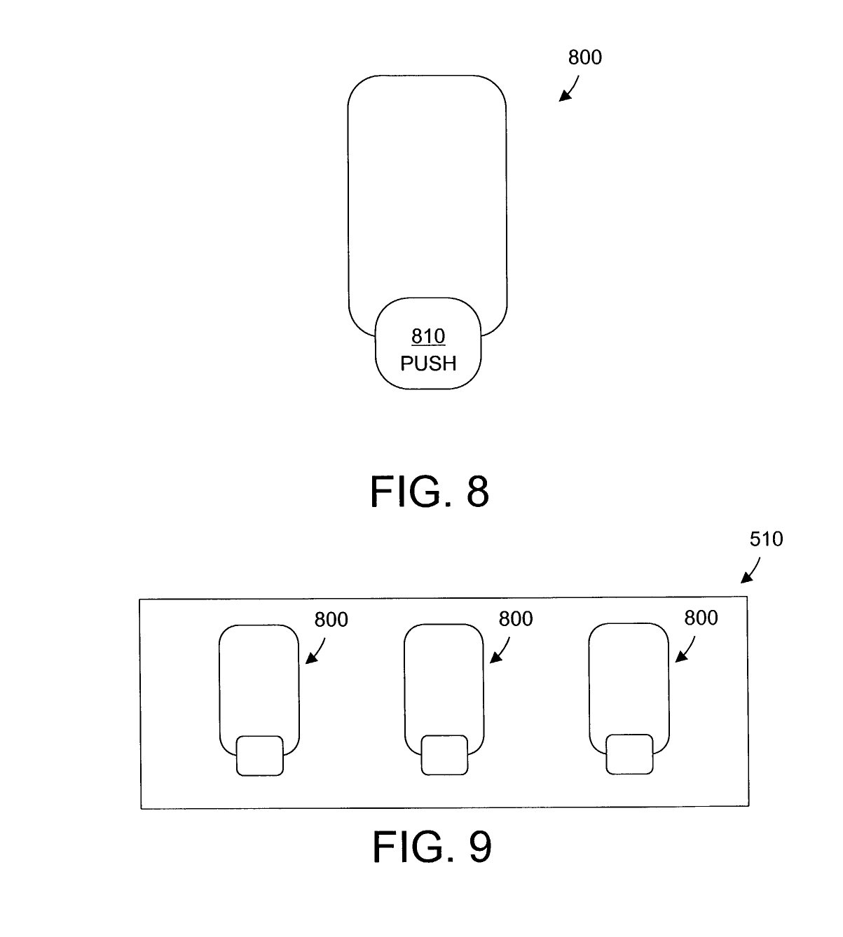

Referring to FIG. 8, a front view of a hand sanitizer dispenser 800 is shown. This dispenser is similar to dispensers that dispense liquid soap in bathrooms. Dispenser 800 as shown in FIG. 8 includes a push lever 810 that a person pushes, typically with the heel of his or her palm, while the fingers of the hand are extended under the push lever 810. As the person pushes on push lever 810, hand sanitizer is dispensed below the push lever 810. In a typical application, a person will put the fingers of one hand under the push lever 810, then push the push lever 810 with the heel of the palm once or twice to dispense hand sanitizer onto the fingers. The person then typically rubs the hand sanitizer on both hands. Of course, alternative methods could be used by customers to dispense and apply the hand sanitizer according to the customer's individual preferences. In addition, alternative types of dispensers could be used within the scope of the preferred embodiments.

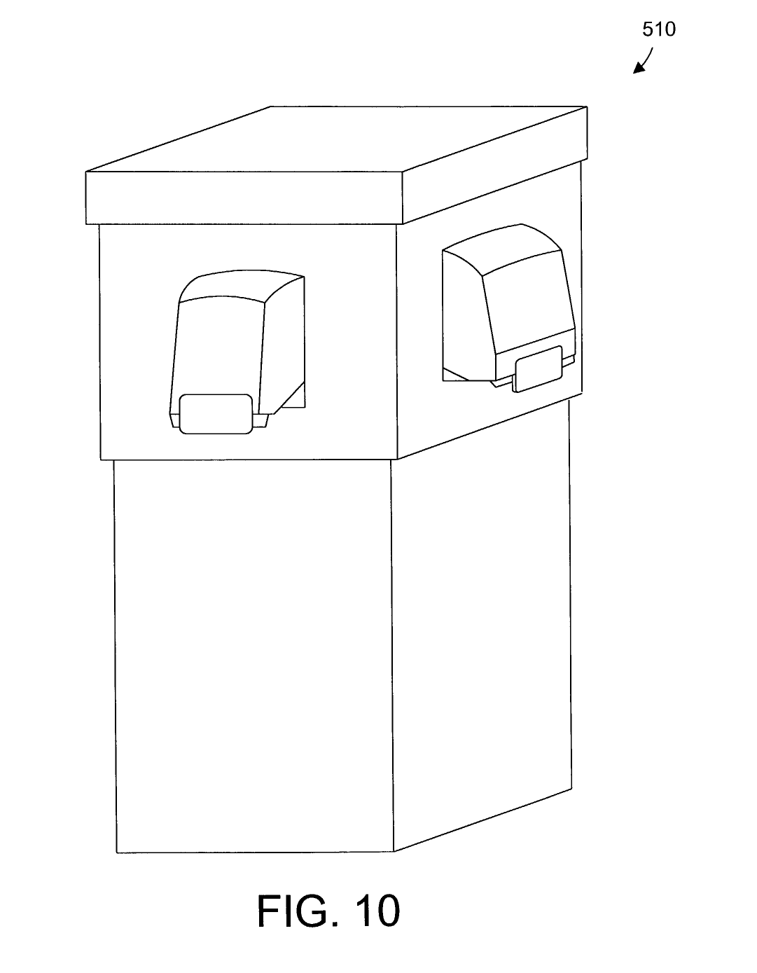

FIG. 9 shows one suitable example of a hand sanitizer station 610 that includes three dispensers 800 mounted next to each other. This type of hand sanitizer station 610 is ideal for mounting on a wall or on top of a food service counter. FIG. 10 shows another suitable example of a hand sanitizer station 610 that is s free-standing kiosk, and that includes four dispensers so that people on all four sides of the kiosk can use dispensers simultaneously. This arrangement works well when placed in the self-serve area of a buffet restaurant, such as shown by 610 in FIG. 7. Of course, other configurations could also be used. The preferred embodiments expressly extend to any suitable way of providing one or more hand sanitizer dispensers in a public non-bathroom area of a restaurant.

The method for a restaurant to do business in accordance with the preferred embodiments can provide a significant competitive advantage in the marketplace. If two Chinese restaurants offer food bars, and one of those restaurants provides one or more hand sanitizer dispensers for customers to sanitize their hands before handling the food at the food bar, customers will perceive that the restaurant that provides the hand sanitizer will be cleaner and a healthier place to eat. In addition, in the “burger wars” that take place in the United Stated between fast food hamburger chains, providing hand sanitizer that allow families (especially with small children) to quickly and conveniently sanitize their hands before eating will draw parents who are attracted to a more sanitary environment for their children.

While the invention has been particularly shown and described with reference to preferred embodiments thereof, it will be understood by those skilled in the art that various changes in form and details may be made therein without departing from the spirit and scope of the invention. For example, while the specific examples presented herein refer to fast food restaurants and buffet restaurants, the methods for doing business disclosed herein could be used in virtually any type or restaurant.

I claim:

1. A method for a restaurant to do business comprising the steps of:
(A) providing hand sanitizer in at least one dispenser in at least one public non-bathroom area of a restaurant; and
(B) providing food to customers of the restaurant.

2. The method of claim 1 further comprising the step of:
(C) encouraging the customers of the restaurant to use the hand sanitizer before handling the food.

3. The method of claim 1 wherein step (A) comprises the step of providing at least one dispenser near a food serving area of the restaurant.

4. The method of claim 3 wherein the food serving area comprises a food service counter where at least one worker in the restaurant provides food to the customers of the restaurant.

5. The method of claim 3 wherein the food serving area comprises a self-serve area.

6. The method of claim 5 wherein the self-serve area comprises a food bar.

7. The method of claim 1 wherein step (A) comprises the step of providing at least one dispenser near an entrance to the restaurant.

8. The method of claim 1 wherein the hand sanitizer comprises a waterless sanitizer.

9. The method of claim 1 wherein the hand sanitizer comprises an alcohol-based sanitizer.

10. The method of claim 1 wherein the hand sanitizer comprises an alcohol-based gel.

11. A method for a restaurant to do business comprising the steps of:
(A) providing at least one serving area for customers of the restaurant to self-serve food; and
(B) providing hand sanitizer in at least one dispenser in the at least one serving area.

12. The method of claim 11 further comprising the step of:
(C) encouraging the customers of the restaurant to use the hand sanitizer before handling the food.

13. The method of claim 11 wherein the hand sanitizer comprises a waterless sanitizer.

14. The method of claim 11 wherein the hand sanitizer comprises an alcohol-based sanitizer.

15. The method of claim 11 wherein the hand sanitizer comprises an alcohol-based gel.

16. A method for a restaurant to do business comprising the steps of:
(A) providing at least one serving area for customers of the restaurant to receive food from workers of the restaurant; and
(B) providing hand sanitizer in at least one dispenser in the at least one serving area.

17. The method of claim 16 further comprising the step of:
(C) encouraging the customers of the restaurant to use the hand sanitizer before handling the food.

18. The method of claim 16 wherein the hand sanitizer comprises a waterless sanitizer.

19. The method of claim 16 wherein the hand sanitizer comprises an alcohol-based sanitizer.

20. The method of claim 16 wherein the hand sanitizer comprises an alcohol-based gel.
